(19) United States
(12) Patent Application Publication
(10) Pub. No.: US 2008/0140885 A1
(43) Pub. Date: Jun. 12, 2008

(54) APPARATUS AND METHOD FOR DETECTING HIGH SPEED USB DEVICE

(76) Inventor: Felix Anton Harold Collins, Christchurch (NZ)

Correspondence Address: KeyGhost Limited, 7 Cockle Lane, Northshore, Christchurch, 8009, omitted

(21) Appl. No.: 11/873,412

(22) Filed: Oct. 17, 2007

(30) Foreign Application Priority Data
Oct. 16, 2006 (NZ) 550536

(51) Int. Cl. G06F 13/38

(52) U.S. Cl. 710/67

(57) ABSTRACT

An apparatus and method for detecting when a high-speed USB device has been connected on a USB data line (12). The detection is achieved by detecting the occurrence of a full-speed idle condition and single ended zero (SE0) condition and at least two edges of a chirp sequence at 400 mV on the USB data line (12). Thus, the monitoring and differentiation between mixed said low speed and said full speed USB data is allowed which enables a USB keystroke recording apparatus (14) to ensure that keystroke data is not missed.

### FIELD OF THE INVENTION

This invention relates to an apparatus and method for detecting the connection of a high speed (480 Mbit/s) USB device to a USB data line. Particularly, but not exclusively, the invention relates to a USB keystroke recording apparatus with improved features including a mechanism for detecting when a high-speed device has been connected along the same data line as a USB keystroke recording apparatus.

### BACKGROUND OF THE INVENTION

Commercially available hardware keystroke monitoring devices and software work by recording the keystrokes typed into a log that can be retrieved later by users. Hardware USB keystroke monitors for USB keyboards have only recently become commercially available.

Existing models convert the USB keyboard to which it is attached to a generic HID (human interface device) keyboard and pass the communications through in the manner of a proxy. This creates problems when other devices are attached downstream from the device, as the keylogger will disable any devices it does not recognise and also any full-speed (12 Mbit/s) or high-speed (480 Mbit/s) devices such as a flash disk or webcam. In this case the presence of a logging device attached to the computer becomes obvious.

Present USB keyloggers are also unable to differentiate between various speeds of USB traffic, including high-speed traffic, which can cause problems when monitoring keystrokes by ‘sniffing’ the USB data line, as mixed speed signals can cause loss of data for the keylogger, and/or the disabling of high-speed devices and the current state of the art keyloggers do not allow recording of keystroke data sent at high speed. For example, if a high speed hub is connected in between the USB keylogger and keyboard, this may cause the keylogger to be unable to monitor the keystroke data sent at high speed. Therefore, there is need for an apparatus and method that can detect the connection of a high-speed device so that the keylogger can adjust its function to ensure the monitoring device remains undetectable to the host computer when low-speed or full-speed devices are connected and having a reduced detectability when a high-speed device is attached, and also force a high speed device to transmit data at full or low speeds, thus allowing the continued monitoring of keystrokes by the device.

### OBJECT OF THE INVENTION

It is an object of this invention to provide a hardware apparatus and method that allows the detection of the connection of a high-speed device to a USB data line, or at least provide the public with a useful choice.

It is also an object of this invention to provide a hardware apparatus and method that enables the undetectable capturing of keystrokes from the low-speed or full-speed USB data stream, while not disabling or ignoring a high-speed USB device that has been connected, or at least provide the public with a useful choice.

### SUMMARY OF THE INVENTION

In the first aspect the invention provides an apparatus for detecting the connection of a high-speed device to a USB bus data line, including:

a USB serial interface chip comprising two single ended receivers and a differential receiver;

wherein said USB serial interface chip detects the occurrence of a full-speed idle condition on said USB bus data line;

wherein said single ended receivers detect the occurrence of a single ended zero condition on said USB bus data line;

wherein said differential receiver detects at least two edges of a chirp sequence at 400 mV on said USB bus data line; and

wherein the continued detection of a single ended zero condition on said USB bus data line by said single ended receivers results in the detection of the connection of a high-speed device to said USB bus data line.

In the second aspect the invention provides a method for detecting the connection of a high-speed device to a USB bus data line, including the steps of:

providing a USB serial interface chip having two single ended receivers and a differential receiver;

detecting a full-speed idle condition on said USB bus data line by said USB serial interface chip;

detecting a single ended zero condition on said USB bus data line by said single ended receivers; and

detecting at least 2 edges of a chirp sequence at 400 mV on said USB bus data line by said differential receiver; and

detecting the continuation of a single ended zero condition on said USB bus data line by said single ended receivers;

whereby the detection of the connection of a high speed device to said USB bus data line is enabled.

In a third aspect the invention provides a method and apparatus for activating the internal USB HUB of a USB keystroke monitoring device on detection of a high-speed device, whereby the high-speed device is prevented from connecting to the host but is not disabled.

Preferably the apparatus may include a feature enabling data from high speed USB (480 Mb/s) transmission to be recorded and differentiated, as well as different kinds of USB data packets.

### BRIEF DESCRIPTION OF THE DRAWINGS

The invention will be described by way of example only with reference to the drawings, in which:

FIG. 1a is a block diagram illustrating a setup with the apparatus connected between the host and keyboard where the keyboard contains an internal USB 2.0 compliant hub which connects to a high-speed USB device.

FIG. 1b is a block diagram illustrating an alternative setup with the apparatus connected between the host and an external USB 2.0 compliant hub, with the hub connected to both the keyboard and the high-speed USB device.

FIG. 2 is a schematic diagram of the basic structure of the apparatus that allows the operation of its described features.

FIG. 3 is a voltage versus time graph illustrating the signal transitions on the USB data lines involved in detecting the connection of a high-speed device according to the invention.

FIG. 4 is a diagram of a finite state machine implementing the apparatus and method for detecting the connection of a high-speed USB device.

### DETAILED DESCRIPTION OF THE PREFERRED EMBODIMENTS

The invention will be described in relation to a USB keystroke-recording apparatus. In this embodiment the hardware apparatus takes its power by intercepting the host power to the keyboard. The apparatus records all keystrokes typed onto the keyboard and these can be later accessed by a user typing in a password in a suitable program such as Microsoft Notepad. A menu is presented allowing various features, including display of the recorded keystrokes, resetting of clock, erasing of log, setting of time intervals for a time/date stamp.

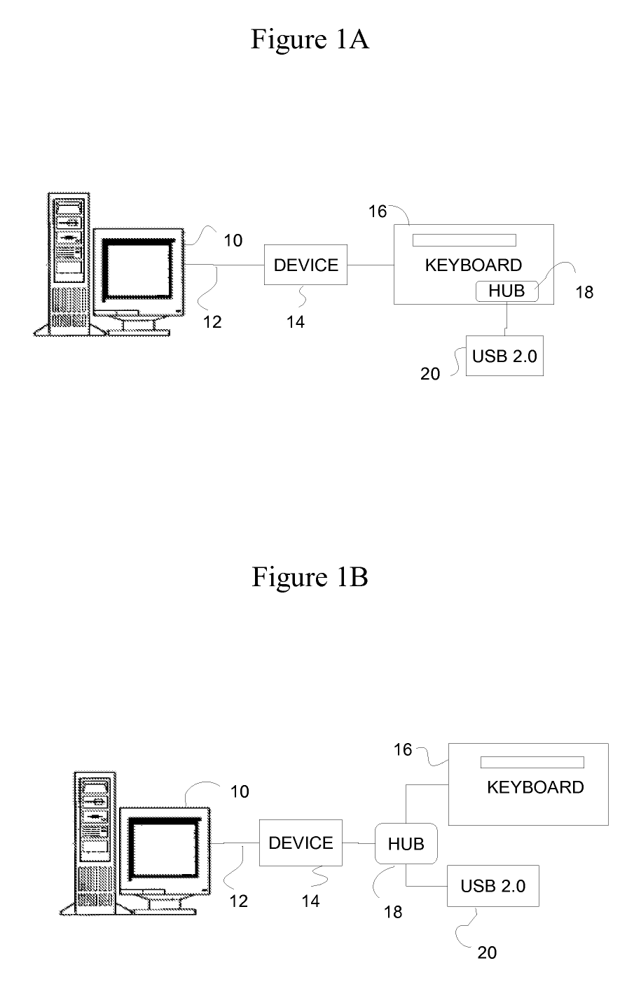

Referring to FIG. 1a, which exemplifies one possible set up, the USB data line 12 connects the host 10 to the keyboard 16 with the apparatus 14 connected in line. The keyboard 16 has an internal USB 2.0 compliant hub 18 which may have one or more USB ports allowing the connection of a high-speed USB device 20. FIG. 1b exemplifies another possible set up with the keyboard 16 and USB device 20 connected to the host 10 through an intermediary external USB 2.0 compliant hub 18.

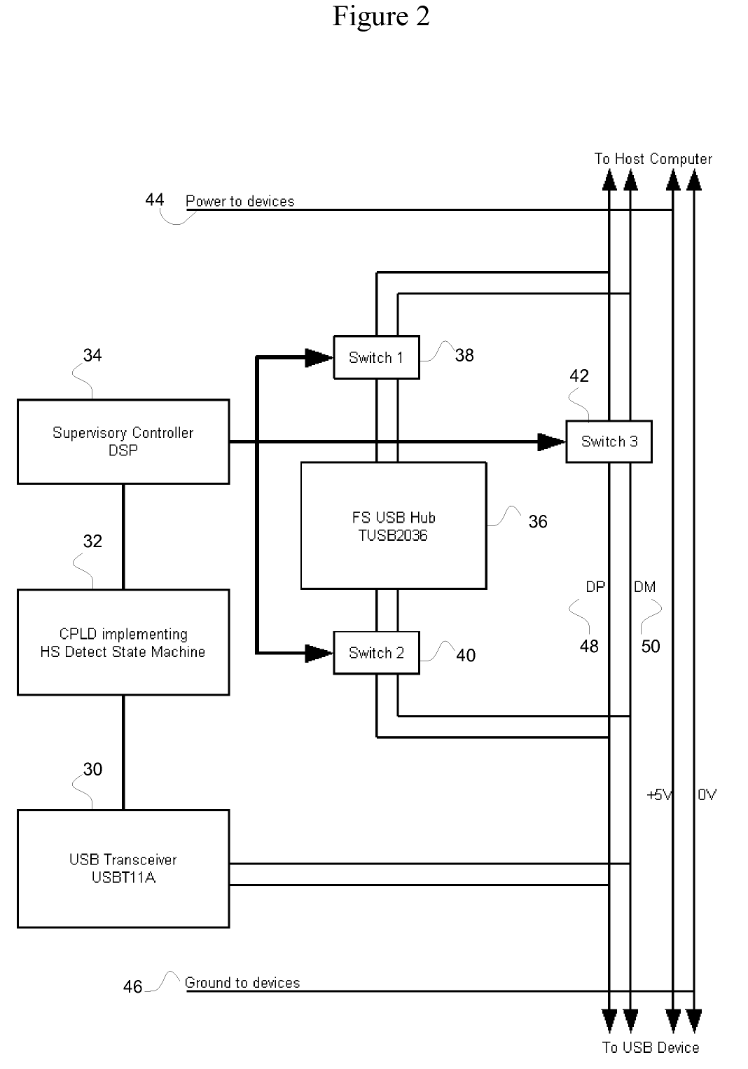

Referring to FIG. 2, in relation to USB keystroke monitoring, the Direct switch 42, and Hub switches 38 and 40, control the connection of the apparatus 14 to the USB Bus, which comprises two differential lines D+ (DP) 48 and D− (DM) 50, as well as power 44 and ground 46 lines. This connection is in two modes. The first mode has the Hub switches 38 and 40 open and the Direct switch 42 closed. In this mode, USB traffic is passed through the apparatus 14 to the downstream devices, which could include a keyboard 16 and other low-speed, full-speed or high-speed devices. The only contact the apparatus has with the USB traffic is through the USB transceiver 30.

In the second mode, when the connection of a high speed USB device 20 is detected by the complex programmable logic device (CPLD) implementing the high speed detect state machine 32, the CPLD 32 activates the supervisory controller DSP 34 which flips the Hub switches 38 and 40 to a ‘closed’ condition and the Direct switch 42 to ‘open’. In this mode the downstream devices are connected to the host PC 10 via the internal full-speed USB Hub 36. This arrangement means any high-speed device 20 connected downstream from the apparatus 14 is forced to connect to the USB HUB 36 at full-speed (12 mbit/s) rather than high speed (480 mbit/s). Therefore, if the apparatus detects the connection of a high speed device, it does not disable it but prevents it connecting at high-speed and therefore being unmonitorable, as the current state of the art does not allow monitoring of high speed USB transmissions.

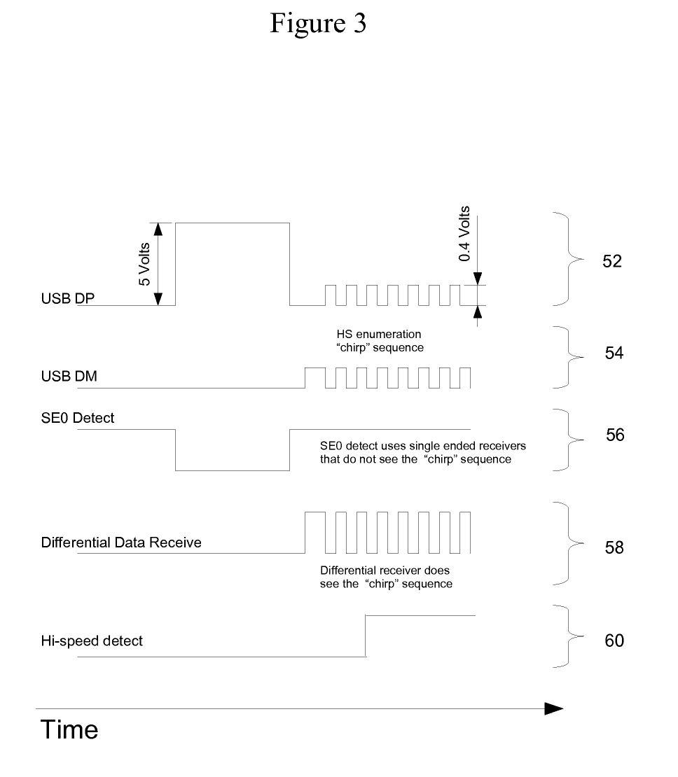

The detection of the connection of a high speed USB device occurs through the USB transceiver which has two single ended receivers and a differential receiver that measures the voltage difference between the DP 48 and DM 50 lines. The differential receiver is sensitive to voltages down to 200 mV and is conventionally used for receiving various data (e.g. keystroke data) according to the USB protocol. The single ended receivers are conventionally involved in picking up special non-differential signalling such as the sending of a single ended zero (SE0) condition. As the apparatus 14 is passively monitoring information transmitted on the USB data line 12 it does not know in advance whether a device connected downstream from the apparatus is high-speed, full-speed or low-speed. When the host 10 detects the connection of a high speed USB device it drives the lines low (DP 48 and DM 50) to indicate a SE0 reset. After this is sent, the high-speed device 20 and the host engage in an exchange of ‘chirp’ sequences at 400 mV. This is not detected by the single ended receivers but can be detected by the differential receiver on the USB transceiver 30. FIG. 3 is a voltage/time graph for the DP line, and DM line 50, single ended receivers 56 and differential receiver 58. The graphs 52 and 54 illustrate what is ‘seen’ by the receivers when detecting the connection of a high speed device. The graph 56 shows the SE0 condition as detected by the single ended receivers. Graph 58 show the data state detected by the differential receiver. For example, the single ended receivers (as shown in graph 56) do not detect the ‘chirp’ sequence indicating the connection of a high speed device 20, while the differential receiver can see this chirp sequence 58 but does not detect the transmission of a SE0 condition 56. After detection of the ‘chirp’ sequence the CPLD 32 signals a high speed detect event 60.

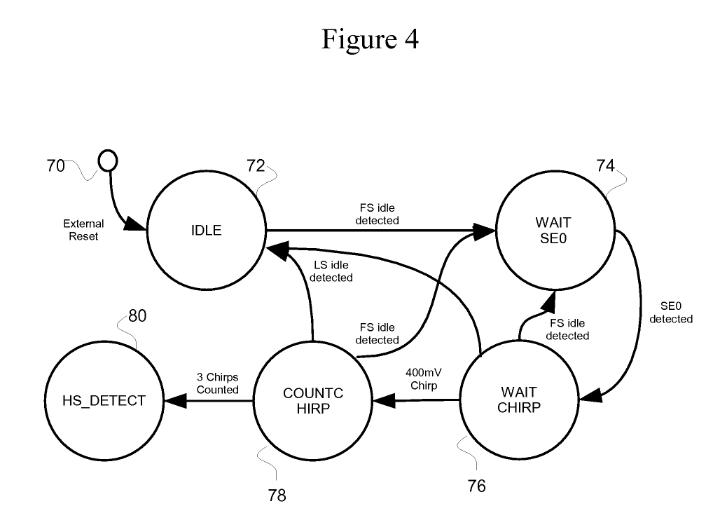

A finite state machine (FSM) implementing the high speed detect functionality can be implemented by a digital circuit in the apparatus 14. However, it should be noted that in a digital circuit, a FSM may be built using a microprocessor, a programmable logic device, a programmable logic controller, logic gates and flip flops or relays. More specifically, a hardware implementation requires a register to store a state variable, a block of combinatorial logic which determines the state transition, and a second block of combinatorial logic that determines the output of the FSM. In our particular embodiment, the FSM is implemented by the CPLD 32. The steps the FSM takes to implement its high speed detect function are illustrated with reference to FIG. 4. Firstly after the occurrence of an external reset event 70, the FSM is placed in an idle state 72 regardless of what state it was in at the time of the external reset. In this state the CPLD is waiting to detect a full-speed idle and ignores other conditions. After a full-speed idle is detected by the DP line being driven high and the DM line driven low, the CPLD 32 moves to the following state 74 where it waits for a SE0 condition to be received by the single ended receivers in the USB transceiver 30. When it detects the SE0 condition, it shifts to the following state 76, where it listens for a 400 mV chirp that will be detected by the differential receiver. After it receives a 400 mV chirp it moves to the next state 78 where it begins counting chirps. After counting 3 falling edges of the high-speed enumeration chirps it shifts to the high-speed detect state 80. It should be noted that in an alternative embodiment only two chirps need to be detected to trigger the transition from state 70 to 80, in this instance 3 chirps were chosen to improve reliability of the high speed detect functionality. Further, as indicated on the FSM diagram, if the correct sequence of events for high speed detect does not eventuate there will be a reversion to a prior state, depending on whether full speed or low speed idle conditions are detected. Preferably, when the high speed detect state 80 is reached, the CPLD will activate the supervisory controller DSP 34 which, in turn, will connect the internal hub 36 by opening direct switch 42 and closing hub switches 38 and 40. As mentioned previously, this will prevent the connection of the high-speed device 20 at 480 mbit/s by forcing it to connect as a full-speed 12 mbit/s device through the internal hub 36.

In an alternative embodiment of the invention the apparatus and method described herein can be implemented in a monitoring device that detects whether the flow of data on a USB data line is high speed (480 mbits/s), full speed (12 mbit/s) or low speed (1.5 mbits/s), and indicates this to a user, for example, though some signalling mechanism such as the flashing of different coloured LEDs on a device on the USB data line.

In another alternative embodiment of the invention using the apparatus and method described herein, a keystroke-recording device that has the ability to record USB keystroke data sent at high speed detects the connection of a high speed device according to the methods described herein, and alters its configuration to allow recording of said high speed data.

While the invention has been described with reference to a hardware apparatus for connection in line between a host computer and keyboard, the invention also applies to apparatuses embedded in keyboards and computers.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

1. An apparatus for detecting the connection of a high-speed device to a USB bus data line, including:
a USB serial interface chip comprising two single ended receivers and a differential receiver;
wherein said USB serial interface chip detects the occurrence of a full-speed idle condition on said USB bus data line;
wherein said single ended receivers detect the occurrence of a single ended zero condition on said USB bus data line;
wherein said differential receiver detects at least two edges of a chirp sequence at 400 mV on said USB bus data line; and
wherein the continued detection of a single ended zero condition on said USB bus data line by said single ended receivers results in the detection of the connection of a high-speed device to said USB bus data line.

2. An apparatus as claimed in claim 1 wherein upon detection of said high-speed device, the internal USB HUB of the apparatus is activated, whereby said high-speed device is prevented from connecting to the host but not disabled.

3. An apparatus as claimed in claim 1 wherein data from a high speed USB (480 Mb/s) transmission is recorded and differentiated from alternative types of USB data packets.

4. A method for detecting the connection of a high-speed device to a USB bus data line, including the steps of:
providing a USB serial interface chip having two single ended receivers and a differential receiver;
detecting a full-speed idle condition on said USB bus data line by said USB serial interface chip;
detecting a single ended zero condition on said USB bus data line by said single ended receivers; and
detecting at least 2 edges of a chirp sequence at 400 mV on said USB bus data line by said differential receiver; and
detecting the continuation of a single ended zero condition on said USB bus data line by said single ended receivers;
whereby the detection of the connection of a high speed device to said USB bus data line is enabled.

5. A method as claimed in claim 4 wherein upon detection of said high-speed device, an internal USB HUB is activated, whereby said high-speed device is prevented from connecting to the host but not disabled.

6. A method as claimed in claim 1 wherein data from a high speed USB (480 Mb/s) transmission is recorded and differentiated from alternative types of USB data packets.
